(19) United States
(12) Patent Application Publication
(10) Pub. No.: US 2013/0186095 A1
(43) Pub. Date: Jul. 25, 2013

(54) Gas turbine with motive fluid driven jet-compressor

(71) Applicant: Jay Stephen KauFman, Kingston, NH (US)

(72) Inventor: Jay Stephen KauFman, Kingston, NH (US)

(21) Appl. No.: 13/374,861

(22) Filed: Jan. 20, 2012

(51) Int. Cl. F02C 7/08; F02C 3/00; F02C 7/22

(52) U.S. Cl. 60/772; 60/39.49

(57) ABSTRACT

A gas turbine prime mover for stationary and motor vehicle application. The gas turbine employs jet compression energized by a pressurized motive fluid to entrain a depressurized suction fluid from the turbine discharge. Combined suction and motive fluids circulate through the combustor or other heating source and the turbine while motive fluid, separated from the turbine discharge, preheats pressurized motive fluid in a heat recovery recuperator or regenerator. Additional features include recovery of heat loss from heating source loss and sub-ambient compression cooling of motive fluid. Cycle efficiency of 70% is attained.

### BACKGROUND

1. Field of Invention

The present invention relates to motive fluid driven jet-compressors (ejectors) for compressing working fluid in gas turbine prime movers, and pertains particularly to an improved compression system for low compression ratio motor vehicle turbines, stationary micro-turbines, and stationary gas turbines with blade cooling.

2. Description of Prior Art

A high efficiency prime mover fueled by renewable energy sources has long been a goal of motor vehicle and stationary engine design to provide energy independence, conserve fossil fuels, and reduce emission of combustion products. The gas turbine offers several advantages over other engines including simplicity, reliability, low maintenance, low emissions, low weight and ability to burn most any fuel or to run on recovered heat. It, therefore, has the potential to provide a universal prime mover, however it is inefficient in small engines for motor vehicle and stationary distributed electric generation, especially with respect to variable speed operation. The effect of low working fluid density leads to excessive compression work, excessive recuperator or regenerator surface area, inefficient turn-down, high exhaust temperature and high stresses at rotational speeds, which may exceed 100,000 rpm. An issue with large stationary gas turbines below 12 Mw(e) is limited application of blade cooling because of insufficient space for rotor cooling channels.

Previous efforts to adapt a gas turbine to motor vehicle use, notably the Chrysler turbine [1] have been unsuccessful. Present efforts to employ micro-turbines [2] for distributed electric generation are proving successful, but with marginal cost advantage. In general, problems with smaller gas turbine applications may be attributed to recuperators or regenerators, which are unnecessarily large and complex. Most gas turbines employ recuperators with fixed surface area to increase cycle efficiency. Because of surface area constraints, especially in motor vehicle application, terminal temperature difference is excessive and the resulting low effectiveness reduces cycle efficiency. These recuperators are constructed of numerous tubes, brazed or welded in complex header arrangements. More advanced state-of-the-art stationary recuperators rely on laminar flow of the working fluid in a plate type matrix with numerous parallel flow passages to realize acceptable effectiveness. Both types of recuperators are large and complex with headers and many closely spaced joints. Another kind of heat exchanger in use is the rotary regenerator which attains higher effectiveness than recuperators by providing passage of the low and high pressure flow streams, alternately over the same heat transfer matrix. Seals are required to minimize leakage from the high to low pressure side and application is limited to moderately pressurized systems. Rotary regenerators also require brazing or welding of numerous parallel flow passages.

### Objects and Advantages

The gas turbine of the present invention has application throughout the micro-turbine capacity range of approximately 20 to 300 kW(e) and to large stationary turbine capacity of about 12 MW(e). Cycle efficiency is improved, especially for low compression ratio operation, by reducing the effect of recuperator terminal temperature difference relative to turbine temperature drop. The resulting reduction of compression work leads to reduced recuperator surface area and alleviates small turbine issues of high exhaust temperature and stresses at high rotational speeds, which are particularly problematic in motor vehicle application. In large stationary turbines lowered compression ratio increases rotor size for a given turbine capacity. As a result, space is made available for blade cooling channels in turbines less than 12 MW(e), enabling increased turbine inlet gas temperature.

Objects of the present invention are:

(a) to provide a motor vehicle gas turbine with high cycle efficiency throughout the vehicle speed range, acceptable rotor speed and low exhaust temperature.
(b) to provide a stationary gas turbine which extends the application of blade cooling to lower capacity engines while maintaining high cycle efficiency at low compression ratio.
(c) to provide highly effective recuperators or regenerators with reduced heat transfer surface area and simplified construction.

Accordingly, advantages of the present invention include the following features:

A feature of the jet compression system of the present invention lies in providing recirculation of depressurized working fluid from the turbine to the combustor or other heating source, while reducing gas turbine heat recovery requirements. The jet-compressor (ejector) works in conjunction with a motive fluid compressor to entrain a suction fluid stream discharging from the turbine into a motive fluid stream preheated in a recuperator or regenerator, while delivering the combined working fluid stream to the heating source. The suction fluid is recirculated at high temperature enabling a small recuperator or regenerator, which recovers heat from only the motive fluid. By maintaining a high ratio of suction fluid to motive fluid terminal temperature difference of the recuperator and expansion temperature drop of the turbine are nearly equalized. This increases cycle efficiency with optimum efficiency occurring at a lower compression ratio; a function of the ratio of suction to motive fluid flow. Gas turbine use is extended to lower speed applications for both motor vehicle and stationary generators due to the established inverse relationship between turbine expansion ratio and the product of rotor speed and rotor diameter squared. Selection of a low molecular weight motive fluid further increases the ratio of suction to motive fluid flow [3]; further lowering the optimum compression ratio.

Another feature of the jet-compression system of the present invention lies in providing a highly effective and compact recuperator or regenerator. Because the jet-compressor enables recirculation of depressurized working fluid, the heat recovery is only required from the lesser motive fluid flow. This reduces recuperator or regenerator heat transfer surface area, potentially eliminating recuperator headers in small enough turbines. In addition, low compression ratio alleviates motive fluid sealing issues with rotary regenerators.

Another feature of the jet-compression system of the present invention lies in providing supplementary recovery of heat from the combustor or other heating source to increase recuperator or regenerator effectiveness by decreasing terminal temperature difference. This feature is also enabled by low motive fluid flow with jet-compression.

Another feature of the jet-compression system of the present invention lies in providing reduced compression work during gas turbine operation with increased compression ratio. Energy storage using phase change of cryogenic fluids is known to offer high fuel efficiency and several cryogenic engines have been built and tested, as described in the literature. Compression cooling described in my earlier U.S. Pat. No. 7,398,841 B2 increases cycle efficiency using a liquefied gas. The liquefied gas, either injected or circulated through a heat exchanger, provides a low temperature heat sink and quasi-isothermal compression of the working fluid.

Still further objects and advantages will become apparent from a consideration of the ensuing description and drawings.

### BRIEF DESCRIPTION OF THE DRAWINGS

The above and other objects and advantages of the present invention will become apparent from the following description when read in conjunction with the accompanying drawings wherein:

FIG. 1 is a schematic illustrating a preferred embodiment of the gas turbine of the present invention with an open heat source and heat sink.

FIG. 2 is a schematic illustrating an alternate preferred embodiment of the gas turbine of the present invention with a closed heat source and heat sink.

FIG. 3 is a schematic illustrating a preferred embodiment of a single circuit regenerative recuperator of the gas turbine of the present invention.

FIG. 4 is a schematic illustrating a preferred embodiment of a heating source recovery circuit of the gas turbine of the present.

FIG. 5 is a schematic illustrating a preferred embodiment of a rotary regenerator of the gas turbine of the present invention.

### DESCRIPTION

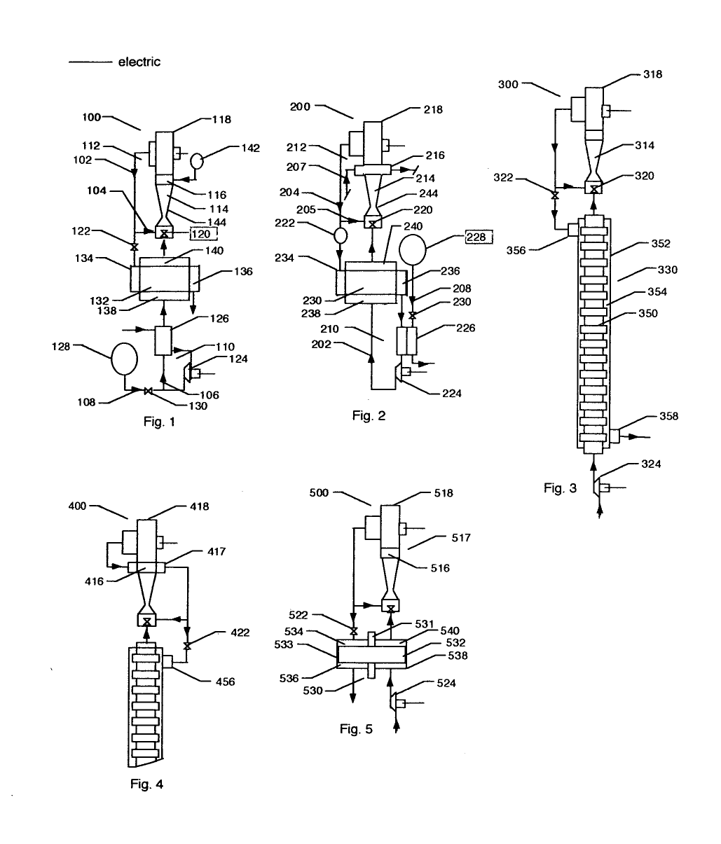

### FIGS. 1 to 5

FIG. 1 is a schematic illustrating a preferred embodiment of a jet-compression gas turbine 100 of the present invention with heat input to a working fluid 102, which is a mixture of a suction fluid 104 and a motive fluid 106. While this basic configuration utilizes an oxygen supported internal combustion heat source and a liquefied air sink, alternate motive fluids must be acceptable for atmospheric discharge. During normal operation the heat sink is the ambient atmosphere and during peaking operation the heat sink is liquefied air 108 which vaporizes upon injection into the motive fluid. A motive fluid circuit 110 and a working fluid circuit 112 are connected to a jet-compressor 114, wherein the two circuits are combined to provide the working fluid to a combustor 116 and a turbine-generator 118 of the gas turbine.

The jet-compressor is energized by injection of pre-heated motive fluid. The motive fluid circuit comprises a motive fluid nozzle 120 of the jet-compressor, a motive fluid separator valve 122, a motive fluid compressor 124, a chiller 126, a liquefied air tank 128, a liquid air valve 130, and a recuperator 132. The recuperator further comprises a low pressure inlet header 134, a low pressure outlet header 136, a high pressure inlet header 138 and a high pressure outlet header 140. Motive fluid from the motive fluid compressor enters the pressurized side of the chiller where it is pre-heated while cooling atmospheric intake air with the liquid air valve open or closed. Pre-heating of the motive fluid is completed in the recuperator while cooling returning motive fluid, which enters the low pressure inlet header via the separator valve and is exhausted to atmosphere.

The working fluid continuously recirculates from the discharge of the turbine-generator to the combustor and through the turbine. The working fluid circuit comprises the combustor, the turbine-generator, a fuel tank 142 and a working fluid nozzle 144 of the jet-compressor. The suction fluid portion of the working fluid is mixed with the high velocity motive fluid from the motive fluid nozzle to pressurize the working fluid mixture, which is accelerated in the working fluid nozzle. Depressurized motive fluid equivalent to the injected pressurized flow, and mixed with combustion products, is discharged to atmosphere.

Estimated performance of the gas-turbine with an exemplary 15 cm (6 in) diameter turbine powering a compact electric drive vehicle with the liquid air valve closed at a cruising speed of 80 km/h (50 mph) is; compression ratio=1.5, air entrainment ratio=1.4 and gas turbine cycle efficiency=62%. The turbine delivers 5.8 kW at 45,000 rpm with gasoline consumption of 62 km/L (145 mpg). Estimated performance at peak acceleration or speed with the liquid air valve fully open is: compression ratio=7, air entrainment ratio=0.9 and gas turbine cycle efficiency=69%. The turbine delivers 69 kW at 89,000 rpm, with liquid air consumption of 2.1 kg/min (4.7 lb/min).

FIG. 2 is a schematic illustrating an alternate preferred embodiment of a jet-compression gas turbine 200 of the present invention with heat input to a working fluid 202, which is a mixture of a suction fluid 204 and a motive fluid 206. This configuration utilizes a recirculating source fluid 207 and a recirculating sink fluid 208. The source fluid provides heat from a selected source such as solar, waste, concentrated oxygen supported combustion or nuclear. During normal operation the sink fluid is the ambient atmosphere and during peaking operation the sink is vaporizing liquefied gas. Recirculation of the source and sink fluids enables selection and conservation of a working fluid mix. The entrainment ratio of suction fluid to motive fluid is modified by the square root of the ratio of molecular weights [3] and appropriate fluid selection with a high ratio enables operation at maximum turbine inlet temperature within constraints of compression work, recuperator surface area and turbine speed.

A motive fluid circuit 210 and a working fluid circuit 212 are connected to a jet-compressor 214, wherein the two circuits are combined to provide the working fluid to a heater 216 and a turbine-generator 218 of the gas turbine. The jet-compressor is energized by injection of pre-heated motive fluid. The motive fluid circuit comprises a motive fluid nozzle 220 of the jet-compressor, a motive fluid separator 222, a motive fluid compressor 224, a chiller 226, a liquefied air tank 228, a liquid air valve 230, and a recuperator 230. The recuperator further comprises a low pressure inlet header 234, a low pressure outlet header 236, a high pressure inlet header 238 and a high pressure outlet header 240. Motive fluid from the motive fluid compressor enters the pressurized side of the chiller where it is pre-heated while cooling recirculating motive fluid with the liquid air valve open or closed. Pre-heating of the motive fluid is completed in the recuperator while continuing to cool motive fluid. Returning motive fluid enters the low pressure inlet header via the separator and continues through the atmospheric side of the chiller back to the suction of the motive fluid compressor.

The working fluid continuously recirculates from the discharge of the turbine-generator to the heater and through the turbine. The working fluid circuit comprises the heater, the turbine-generator and a working fluid nozzle 244 of the jet-compressor. The suction fluid portion of the working fluid is mixed with the high velocity motive fluid from the motive fluid nozzle to pressurize the working fluid mixture, which is accelerated in the working fluid nozzle. Depressurized motive fluid equivalent to the injected pressurized flow is extracted in the separator and returned to the motive fluid circuit.

Estimated performance of the gas-turbine with exemplary suction air, motive helium and a 17.8 cm (7 in) diameter turbine powering a compact electric drive vehicle at cruising speed of 80 km/h (50 mph) is; compression ratio=1.5, air entrainment ratio=2.2 and gas turbine cycle efficiency is 60%. The turbine delivers 6.7 kW at 39,000 rpm and gasoline consumption is 56 km/L (133 mpg). Estimated performance at peak acceleration or speed with the liquid air valve fully open is: compression ratio=2, air entrainment ratio=0.83 and gas turbine cycle efficiency=55%. The turbine delivers 66 kW at 82,000 rpm, with air consumption of 1.3 kg/min (2.9 lb/min).

FIG. 3 is a schematic illustrating a preferred embodiment of a jet-compression gas turbine 300 of the present invention with a single tube recuperator 330 for motive fluid heat recovery. The recuperator comprises a concentric assembly of an externally corrugated tube 350 and a containment tube 352, which form an annulus 354. Pressurized motive fluid is preheated in the central tube by transfer of heat from depressurized motive fluid in the annulus. A single corrugated tube provides enhanced heat transfer sufficient to match recuperator heat recovery to turbine exhaust heat without the use of headered parallel flow channels.

Depressurized motive fluid from a motive fluid separation valve 320 enters an inlet pipe connection 356 and continues through the annulus to atmosphere via an outlet pipe connection 358. Simultaneously, heat is recovered from the depressurized motive fluid to pressurized motive fluid flowing in the corrugated tube from a motive fluid compressor 324 to a motive fluid nozzle 320 of a jet-compressor 314.

Estimated effectiveness of the motive fluid recuperator is over 90% with a heat duty approximately 33% as for the recuperator of a conventional gas turbine with a shaft driven compressor.

FIG. 4 is a schematic illustrating a preferred embodiment of a jet-compression gas turbine 400 of the present invention with a heat exchanger 417 for recovery of heat loss from a heater 416 to depressurized motive fluid in a recuperator 430. The heat exchanger, in contact with the heater, transfers heat normally lost from the heater by flow of depressurized motive fluid from a motive fluid separator valve 422 to an inlet pipe connection 456.

Recuperator effectiveness of over 98% is estimated due to reduced hot end terminal temperature difference. The gain in effectiveness increases with decreasing compression ratio in proportion to the ratio of working fluid flow to motive fluid flow. Estimated heat transfer surface area is 20% as compared to the recuperator of a gas turbine of comparable capacity.

FIG. 5 is a schematic illustrating a preferred embodiment of a jet-compression gas turbine 500 of the present invention with a rotary regenerator 530 for motive fluid heat recovery. The regenerator comprises a matrix support shaft 531, a rotating heating surface matrix 532 and a duct assembly 533 for preheating pressurized motive fluid by transfer of heat from depressurized motive fluid.

Depressurized motive fluid from a motive fluid separation valve 520 enters a depressurized inlet duct 534 and continues through the matrix to atmosphere via a depressurized outlet duct 536. Simultaneously, heat is recovered from the depressurized motive fluid to pressurized motive fluid entering a pressurized inlet duct 538 from a motive fluid compressor 524 and continuing through the matrix to a motive fluid nozzle 520 of a jet-compressor 514 via a pressurized outlet duct 540.

Regenerator effectiveness of over 98% is estimated due to reduced hot end terminal temperature difference. The gain in effectiveness increases with decreasing compression ratio in proportion to the ratio of working fluid flow to motive fluid flow. Estimated heat transfer surface area is 20% as compared to the regenerator of a gas turbine of comparable capacity.

### SUMMARY, RAMIFICATIONS AND SCOPE

Accordingly, it is shown that the jet-compression gas turbine of this invention improves engine thermal efficiency in both motor vehicle and stationary application. In addition, it overcomes problems of gas-turbine application in motor vehicles caused by the wide range of turbine speed, and in stationary application by extending blade cooling limits.

Although the description above contains many specific details, these should not be construed as limiting the scope of the invention but as merely providing illustration of some of the preferred embodiments of this invention. For example, jet-compressors can be connected in series to increase compression ratio or connected in parallel to provide increased working fluid flow. Similarly, turbines, either radial or axial types having either electrical or mechanical output, can be connected in series to lower expansion ratio and speed, or connected in parallel to increase power. In addition, various motive and suction fluids may be appropriately mixed, oxygen supplied as required for combustion and quasi-isothermal expansion and compression used.

Thus the scope of the invention should be determined by the appended claims and their legal equivalents, rather than by the examples given.

I claim:

1. A gas turbine comprising jet compression means, regenerative heat recovery means, heating source means, motive fluid pressurization means, and fluid separation means, wherein said jet compression means entrains depressurized suction fluid from said turbine into a preheated jet of motive fluid from said recovery means while circulating a working fluid mixture of motive and suction fluids to said heating source means for expansion through said turbine, and wherein said heat recovery means preheats pressurized motive fluid by transfer of heat from depressurized motive fluid.

2. The motive fluid pressurization means of claim 1, wherein motive fluid is cooled to less than ambient temperature by transfer of heat from motive fluid to a liquefied gas, to reduce motive fluid pressurization work and motive fluid use.

3. The motive fluid pressurization means of claim 2 comprising liquefied gas heat sink means, wherein motive fluid is cooled to less than ambient temperature by mixing with a liquefied gas, to reduce motive fluid pressurization work and motive fluid use.

4. The heat source means of claim 1 comprising oxygen injection means and fuel injection means, whereby oxygen supported internal combustion of fuel is maintained.

5. The separation means of claim 1 comprising fluid extraction means, whereby motive fluid having lower molecular weight than the molecular weight of suction fluid is extracted for heat recovery and circulation by said pressurization means to conserve motive fluid.

6. The separation means of claim 1 comprising controllable valve means, whereby motive fluid having the same molecular weight as the molecular weight of suction fluid is extracted for heat recovery and discharge to atmosphere.

7. The heat recovery means of claim 1 comprising one annular channel and one central channel for transfer of heat from depressurized motive fluid in said annular channel to pressurized motive fluid in said central channel, wherein the quantity of heat recovered is comparable to the exhaust heat of said turbine.

8. The annular channel of claim 7 comprising heat transfer enhancement means attached to said annular channel.

9. The heat source means of claim 7 comprising heat exchange means for transferring waste heat from said heat source means to increase the temperature of depressurized motive fluid entering said annular channel.

10. A method for operating a gas turbine comprising the steps of:
a. entraining depressurized suction fluid from said turbine into a preheated jet of motive fluid from motive fluid regenerative heat recovery means by jet compression means of said gas turbine,
b. circulating a working fluid mixture of motive and suction fluids from said jet compression means to turbine heat source means for expansion through said turbine,
c. extracting depressurized motive fluid from a working fluid mixture of suction fluid and motive fluid in fluid separation means, and
d. recovering heat said from depressurized motive fluid while heating motive fluid from motive fluid pressurization means in said heat recovery means of said gas turbine, whereby
working fluid temperature rise of said heat source means approaches working fluid temperature drop of said turbine with respect to decreasing expansion ratio of said turbine.

11. The method of claim 10 further comprising the step of cooling motive fluid to less than ambient temperature by transfer of heat from motive fluid to a liquefied gas, to reduce motive fluid pressurization work and motive fluid use.

12. The method of claim 11 wherein said step of cooling motive fluid to less than ambient temperature comprises the step of mixing motive fluid with a liquefied gas.

13. The method of claim 10 wherein said step of circulating a working fluid mixture comprises injection of oxygen and fuel into said heat source means to provide oxygen supported internal combustion of fuel.

14. The method of claim 10 wherein said step of extracting depressurized motive fluid having lower molecular weight than the molecular weight of suction fluid comprises separation means for extraction of motive fluid for heat recovery.

15. A gas turbine with regenerative heat recovery comprising:
a heat source for heating compressed gas turbine working fluid,
a jet compressor for compressing gas turbine working fluid by entraining a suction fluid portion of depressurized turbine working fluid into a preheated jet of motive fluid while circulating the working fluid mixture of motive and suction fluids.
a fluid separator for extracting motive fluid from depressurized working fluid,
a motive fluid pressurizer for pressurizing motive fluid, and
a heat exchanger for recovering heat from depressurized motive fluid while preheating pressurized motive fluid.

16. The heat exchanger of claim 15 comprising rotatating heat transfer surface, whereby said heat exchanger is a rotary regenerator.

17. The motive fluid pressurizer of claim 15, wherein motive fluid is cooled to less than ambient temperature by transfer of heat from motive fluid to a liquefied gas, to reduce motive fluid pressurization work and motive fluid use.

18. The motive fluid pressurizer of claim 17 comprising a liquefied gas heat sink, wherein motive fluid is cooled to less than ambient temperature by mixing with a liquefied gas, to reduce motive fluid pressurization work and motive fluid use.

19. The heat source of claim 15 comprising injection of oxygen and fuel, whereby oxygen supported internal combustion of fuel is maintained.

20. The fluid separator of claim 15, whereby motive fluid having lower molecular weight than the molecular weight of suction fluid is extracted for recovery of heat to pressurized motive fluid to conserve motive fluid.
